(19) United States
(12) Patent Application Publication
(10) Pub. No.: US 2020/0398734 A1
(43) Pub. Date: Dec. 24, 2020

(54) MOBILE ARTICULATING VEHICLE SERVICE SHELTER

(71) Applicant: Zippity, Inc., Boston, MA (US)

(72) Inventors: Edward Chamberlin Warren, III, Bethlehem, NH (US); Henry A. Ebosh, Nashua, NH (US)

(21) Appl. No.: 16/701,437

(22) Filed: Dec. 3, 2019

Related U.S. Application Data
(60) Provisional application No. 62/864,151, filed on Jun. 20, 2019.

(51) Int. Cl. B60P 3/42

(52) U.S. Cl. CPC B60P 3/42; E04H 15/06

(57) ABSTRACT

Disclosed in a transportable shelter that is configured to have an un-deployed state and a deployed state. In some embodiments, the shelter includes a first panel, a second panel, and third panel. Each of the panels has a first edge and a second edge that is generally parallel to and spaced a first distance from the first edge. The first edge of the first panel is pivotally coupled to an upper region of a first side of a wheeled vehicle and is generally horizontal with respect to a surface underneath the wheeled vehicle. The first edge of the second panel is pivotally coupled to the second edge of the first panel. The first edge of the third panel is pivotally coupled to the second edge of the second panel. When the transportable shelter is in the deployed state, the second edge of the third panel is spaced apart from the first side by a fourth distance that is at least as great as the first distance.

### CROSS-REFERENCE TO RELATED APPLICATIONS

This application claims the benefit under 35 U.S.C. § 119(e) of U.S. Provisional Application Ser. No. 62/864,151, entitled MOBILE ARTICULATING VEHICLE SERVICE SHELTER, filed Jun. 20, 2019, the entire contents of which are hereby incorporated herein by reference for all purposes.

### BACKGROUND

Typically, when a vehicle breaks down at a remote location, a tow truck is used to transport the vehicle to a service station for repairs. Tow trucks can be expensive, however, particularly when they need to travel long distances. Accordingly, tow trucks typically transport disabled vehicles to nearby service stations, which may have less capable personnel and/or be more expensive than service providers the owners of such vehicles ordinarily would have chosen.

### SUMMARY

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

In some embodiments, a transportable shelter is configured to have an un-deployed state and a deployed state and comprises a first panel, a second panel and third panel. The first panel has a first edge and a second edge, the second edge of the first panel being generally parallel to and spaced a first distance from the first edge of the first panel. The second panel has a first edge and a second edge, the second edge of the second panel being generally parallel to and spaced a second distance from the first edge of the second panel. The third panel has a first edge and a second edge, the second edge of the third panel being generally parallel to and spaced a third distance from the first edge of the third panel. The first edge of the first panel is pivotally coupled to an upper region of a first side of a wheeled vehicle and is generally horizontal with respect to a surface underneath the wheeled vehicle. The first edge of the second panel is pivotally coupled to the second edge of the first panel. The first edge of the third panel is pivotally coupled to the second edge of the second panel. When the transportable shelter is in the deployed state, the second edge of the third panel is spaced apart from the first side by a fourth distance that is at least as great as the first distance.

In some embodiments, a method involves operating a transportable shelter that includes a first panel, a second panel, and a third panel, wherein the first panel has a first generally planar side and a second generally planar side, the second generally planar side of the first panel is opposite the first generally planar side of the first panel, the second panel has a first generally planar side and a second generally planar side, the second generally planar side of the second panel is opposite the first generally planar side of the second panel, the third panel has a first generally planar side and a second generally planar side, the second generally planar side of the third panel is opposite the first generally planar side of the third panel, the first panel has a first edge and a second edge, the second edge of the first panel is generally parallel to and spaced a first distance from the first edge of the first panel, the second panel has a first edge and a second edge, the second edge of the second panel is generally parallel to and spaced a second distance from the first edge of the second panel, the third panel has a first edge and a second edge, and the second edge of the third panel is generally parallel to and spaced a third distance from the first edge of the third panel. According to the method, the first panel is caused to rotate about a first pivot point between the first edge of the first panel and a first side of a wheeled vehicle so that the first panel transitions from a first position in which the first generally planar side of the first panel is generally vertical with respect to a surface underneath the wheeled vehicle to a second position in which the first generally planar side is generally horizontal with respect to the surface, the second panel is caused to rotate through more than ninety degrees with respect the first panel and about a second pivot point between the first edge of the second panel and the second edge of the first panel so that the second panel transitions from a third position in which the second generally planar side of the second panel is generally parallel to the second generally planar side of the first panel to a fourth position in which a first interior angle between the second generally planar side of the second panel and the second generally planar side of the first panel is greater than ninety degrees, and the third panel is caused to rotate through more than ninety degrees with respect the second panel and about a third pivot point between the first edge of the third panel and the second edge of the second panel so that the third panel transitions from a fifth position in which the second generally planar side of the third panel is generally parallel to the second generally planar side of the second panel to a sixth position in which a second interior angle between the second generally planar side of the third panel and the second generally planar side of the second panel is greater than ninety degrees and in which the second edge of the third panel is spaced apart from the first side.

### BRIEF DESCRIPTION OF THE DRAWINGS

For purposes of reading the description of the various embodiments below, the following descriptions of the sections of the specification and their respective contents may be helpful.

FIG. 1 shows a perspective view of a first example embodiment of a mobile service shelter configured in accordance with the present disclosure;

FIG. 2 shows a slightly-elevated side view of the example shelter shown in FIG. 1, where the shelter 100 is also in its deployed state;

FIG. 3 shows a perspective view of the example shelter shown in FIGS. 1 and 2, where the shelter in its un-deployed state;

FIG. 4A shows a first step of a first deployment technique for the articulating panels of the example shelter shown in FIGS. 1-3;

FIG. 4B shows a second step of a first deployment technique for the articulating panels of the example shelter shown in FIGS. 1-3;

FIG. 4C shows a third step of a first deployment technique for the articulating panels of the example shelter shown in FIGS. 1-3;

FIG. 5A shows a first step of a second deployment technique for the articulating panels of the example shelter shown in FIGS. 1-3;

FIG. 5B shows a second step of a second deployment technique for the articulating panels of the example shelter shown in FIGS. 1-3;

FIG. 5C shows a third step of a second deployment technique for the articulating panels of the example shelter shown in FIGS. 1-3;

FIG. 6A shows a second example implementation of a mobile service shelter in a first state of deployment;

FIG. 6B shows the example shelter shown in FIG. 6A in a second state of deployment;

FIG. 6C shows the example shelter shown in FIG. 6A in a third state of deployment;

FIG. 6D shows the example shelter shown in FIG. 6A in a fourth state of deployment;

FIG. 6E shows the example shelter shown in FIG. 6A in a fifth state of deployment;

FIG. 6F shows the example shelter shown in FIG. 6A in a sixth state of deployment;

FIG. 6G shows the example shelter shown in FIG. 6A in a seventh state of deployment;

FIG. 6H shows the example shelter shown in FIG. 6A in a second state of deployment and use;

FIG. 6I shows a second example implementation of a mobile service shelter in a first state of deployment and use;

FIG. 7 shows FIGS. 6A through 6I as a sequence of steps, identified as steps 1 through 9, respectively, for deploying a mobile shelter and lifting a vehicle within its interior region;

FIG. 8 shows a side view of the example shelter shown in FIGS. 1-3 in the deployed state, and illustrates example linkages and linear actuators that may be used in some embodiments to control the positioning and movement of its panels;

FIG. 9A shows the example shelter shown in FIGS. 1-3, including the linkages and actuators shown in FIG. 8, in the un-deployed state;

FIG. 9B shows detail of the region A shown in FIG. 9A;

FIG. 10 shows the example shelter configuration shown in FIGS. 9A and 9B, but with the actuators and linkages omitted;

FIG. 11 shows another example embodiment of a mobile articulating vehicle service shelter in its deployed state; and

FIG. 12 shows a cross section of the shelter 1100 shown in FIG. 11 in its un-deployed state.

### DETAILED DESCRIPTION

Offered is a vehicle service shelter that can be readily transported to and quickly deployed at the location of a vehicle in need of maintenance and/or repairs, thus obviating the need to transport the vehicle to a nearby service station.

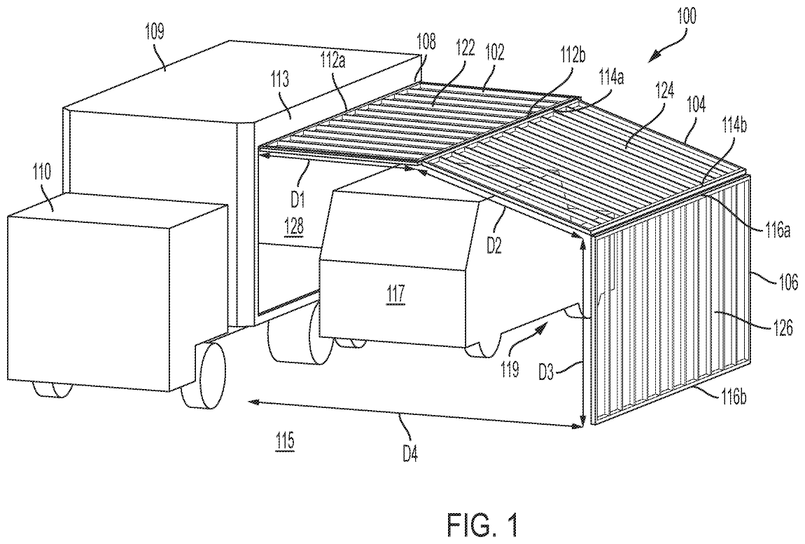

FIG. 1 shows a perspective view of an example embodiment of a mobile service shelter 100 configured in accordance with the present disclosure. FIG. 1 shows the shelter 100 in its deployed state. As shown, the shelter 100 may include a set of three articulating panels 102, 104, 106 that may be deployed from a first side 108 of a cargo portion 109 of a transport vehicle 110. In some embodiments, each of the three panels 102, 104, 106 may be a rigid structure. Although certain regions of the panels 102, 104, 106 appear to be translucent in the drawings, it should be appreciated that such regions may actually represent opaque (and preferably lightweight) materials, such as aluminum sheets, disposed over or otherwise supported by rigid structural members.

As FIG. 1 illustrates, a first edge 112a of the first panel 102 may be pivotally connected to an upper region 113 of the first side 108 of the cargo portion 109 and may be generally horizontal with respect to a surface 115 underneath the transport vehicle 110. The first panel 102 may have a generally rectangular shape and may thus also have a second edge 112b that is generally parallel to and located a first distance D1 from the first edge 112a.

A first edge 114a of the second panel 104 may be pivotally connected to the second edge 112b of the first panel 102. Like the first panel 102, the second panel 104 may have a generally rectangular shape and may thus similarly have a second edge 114b that is generally parallel to and located a second distance D2 from the first edge 114a.

A first edge 116a of the third panel 106 may be pivotally connected to the second edge 114b of the second panel 104. Like the first panel 102 and the second panel 104, the third panel 106 may have a generally rectangular shape and may thus similarly have a second edge 116b that is generally parallel to and located a third distance D3 from the first edge 116a.

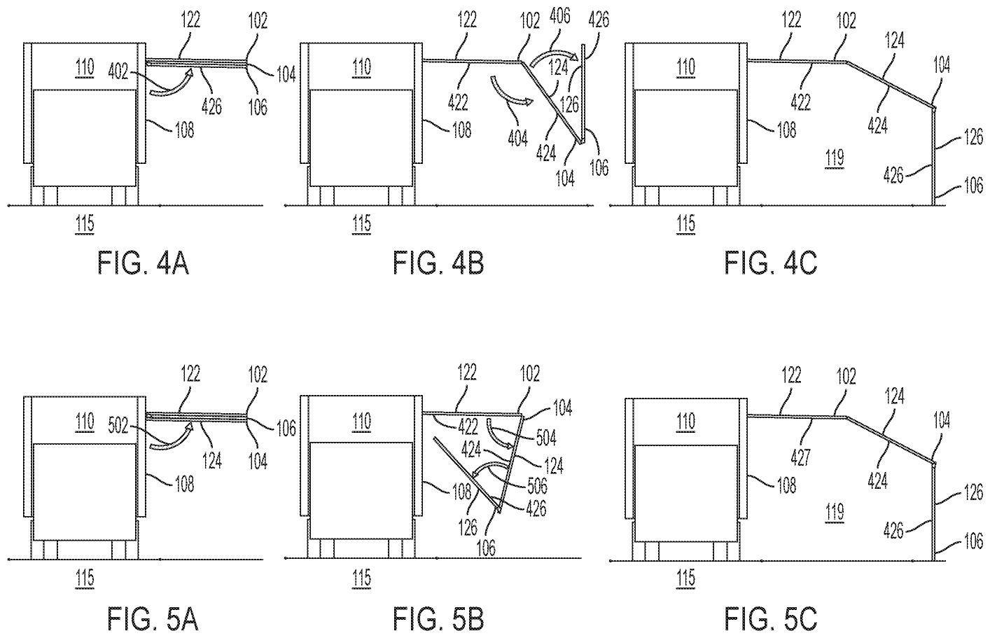

As illustrated, the first panel 102 may be disposed generally in a first plane that intercepts both the first edge 112a and the second edge 112b of the first panel 102, the second panel 104 may be disposed generally in a second plane that intercepts both the first edge 114a and the second edge 114b of the second panel 104, and the third panel 106 may be disposed generally in a third plane that intercepts both the first edge 116a and the second edge 116b of the third panel 106. In addition, the first panel 102 may have a first generally planar side 122 and a second generally planar side 422 (identified in FIGS. 4B, 4C, 5B, and 5C) opposite the first generally planar side 122, the second panel 104 may have a first generally planar side 124 and a second generally planar side 424 (identified in FIGS. 4B, 4C, 5B, and 5C) opposite the first generally planar side 124, and the third panel 106 may have a first generally planar side 126 and a second generally planar side 426 (identified in FIGS. 4B, 4C, 5B, and 5C) opposite the first generally planar side 126.

As illustrated in FIG. 1, when the shelter is in its deployed state, the second edge 116b of the third panel 106 may be spaced apart from the first side 108 of the vehicle by a fourth distance D4. As can be seen, the fourth distance D4 may be at least as great as the first distance D1 and, in some embodiments, due to the presence of the second panel 104 between the first panel 102 and the third panel 106, may be approximately the sum of the first distance D1 and the second distance D2.

As FIG. 1 depicts, when the example shelter 100 is deployed in such a fashion, it may readily accommodate a vehicle 117 that is about the same width and nearly as tall as the cargo portion 109 of the transport vehicle 110 from which the shelter 100 is deployed, and may also provide significant clearance on either side of the vehicle 117 within an interior region 119 of the shelter 100 to allow service personnel ample room to service and/or repair the vehicle 117. As shown, an interior region 128 of the cargo portion 109 may be exposed to the interior region 119 of the shelter 110, thus allowing service technicians to access equipment, tools, etc., within the interior region 128 while they are servicing the vehicle 117 within the shelter 100. In some embodiments, the opening in the side of the cargo portion 109 that allows the interior region 128 to be so exposed when the shelter 100 is in the deployed state may be covered by at least the first panel 102 when the shelter 100 is in the un-deployed state.

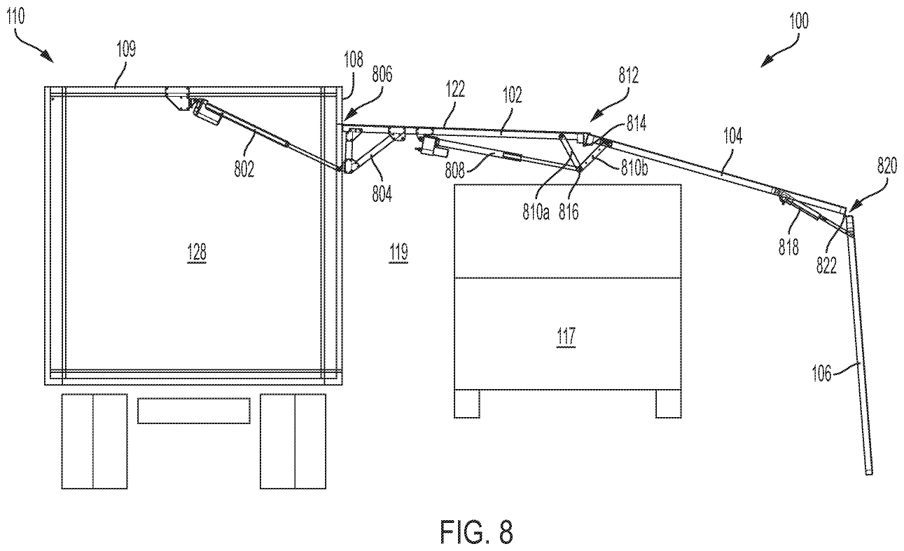

Although not illustrated in FIG. 1, in some embodiments, each of the panels 102, 104, and 106 may be moved with respect to the side 108 of cargo portion 109 and/or with respect to adjacent panels using one or more linear actuators or other drivers coupled between such elements, such as mechanical or electromechanical worm gear drive actuators, hydraulic linear actuators, pneumatic linear actuators, etc. Examples of linear drivers that may be used for such purposes are described below in connection with FIG. 8

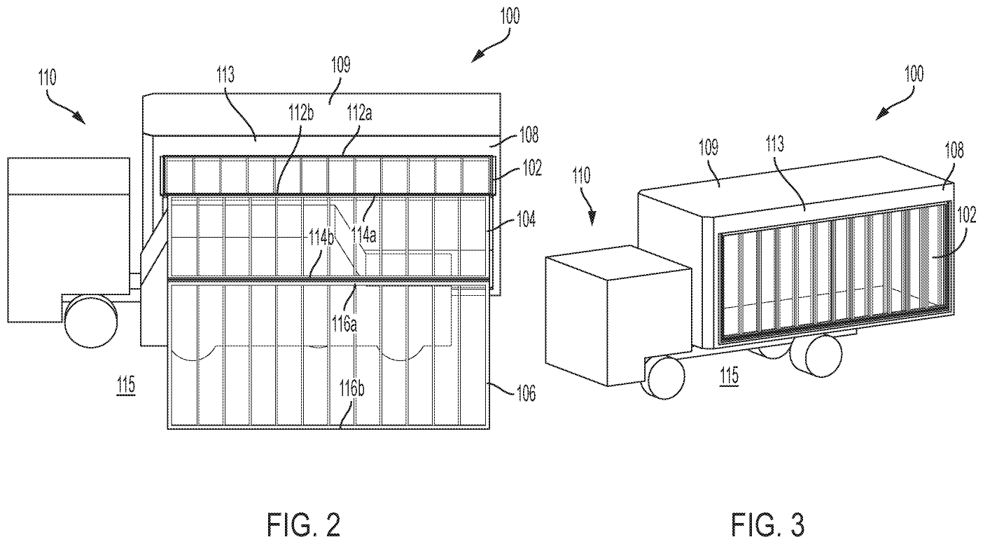

FIG. 2 shows a slightly-elevated side view of the example shelter 100 shown in FIG. 1, where the shelter 100 is also in its deployed state. FIG. 3, on the other hand, shows a perspective view of the example shelter 100 shown in FIG. 1, where the shelter 100 in its un-deployed state. Examples of techniques that may be used to selectively transition the shelter 100 between its un-deployed and deployed states are described below.

FIGS. 4A-C and 5A-C show two alternative deployment techniques for the articulating panels 102, 104, 106. Each of FIGS. 4A-C and 5A-C represents the shelter 100 as viewed from the front of the transport vehicle 110 in a respective state of deployment. The direction of the curved arrows indicate the direction in which the panels may be capable of rotating with respect to the other depicted elements in each implementation. Hinges or other movable fasteners may be positioned on the cargo portion 109 and on the panels 102, 104, 106 to allow rotation in the manner indicated in each case.

In the first implementation, shown in FIGS. 4A-C, the first panel 102 may be rotated in a counter-clockwise direction with respect to the side 108 of the cargo portion 109 (see arrow 402 in FIG. 4A), the second panel 104 may be rotated in a counter-clockwise direction with respect to the first panel 102 (see arrow 404 in FIG. 4B), and the third panel 106 may be rotated in a clockwise direction with respect to the second panel 104 (see arrow 406 in FIG. 4B).

In the second implementation, shown in FIGS. 5A-C, the first panel 102 may be rotated in a counter-clockwise direction with respect to the side 108 of the cargo portion 109 (see arrow 502 in FIG. 5A), and the second panel 104 may be rotated in a counter-clockwise direction with respect to the first panel 102 (see arrow 504 in FIG. 5B). The rotational movement of the first panel 102 and the second panel 104 is thus similar to that of the first implementation (shown in FIGS. 4A-C). In the second implementation, however, the third panel 106 may be rotated in a counter-clockwise direction with respect to the second panel 104 (see arrow 506 in FIG. 5B), rather in a clockwise direction. Thus, in the second implementation (shown in FIGS. 5A-C), when the shelter is in the un-deployed state, the third panel 106 may be located between the first panel 102 and the second panel 104, whereas in the first implementation (shown in FIGS. 4A-C), when the shelter 100 is in the un-deployed state, the second panel 104 may be located between the first panel 102 and the third panel 106.

As shown in FIGS. 4A-C and 5A-C, the first panel 102 may have a second generally planar side 422 opposite the first generally planar side 122 (also shown in FIG. 1) of the first panel 102, the second panel 104 may have a second generally planar side 424 opposite the first generally planar side 124 (also shown in FIG. 1) of the second panel 104, and the third panel 106 may have a second generally planar side 426 opposite the first generally planar side 124 (also shown in FIG. 1) of the third panel 106. As illustrated in FIGS. 4C and 5C, in each of the two alternative implementations, when the shelter 100 is in the deployed state, the second generally planar side 422 of the first panel, the second generally planar side 424 of the second panel 104, and the second generally planar side 426 of the third panel 106 all face the interior region 119 of the shelter 100.

In both implementations shown, when the shelter 100 is in the un-deployed state, the first generally planar side 122 of the first panel 102 may be generally vertical with respect to the surface 115 underneath the transport vehicle 110 and may face away from the cargo portion 109 so as to effectively form a portion of the first side 108 of the cargo portion 109. In the first implementation (shown in FIGS. 4A-C), when the shelter 100 is in the un-deployed state, the second generally planar side 424 of the second panel 104 may directly face the second generally planar side 422 of the first panel 102, and the first generally planar side 124 of the second panel 104 may directly face the first generally planar side 126 of the third panel 106. In the second implementation (shown in FIGS. 5A-C), on the other hand, when the shelter 100 is in the un-deployed state, the second generally planar side 422 of the first panel 102 may directly face the first generally planar side 126 of the third panel 106, and the second generally planar side 424 of the second panel 104 may directly face the second generally planar side 426 of the third panel 106.

Also, in both implementations shown, when the shelter 100 is in the un-deployed state, the first plane in which the first panel 102 is generally disposed, the second plane in which the second panel 104 is generally disposed, and the third plane in which the third panel 106 is generally disposed may all be generally vertical with respect to the surface 115 underneath the vehicle.

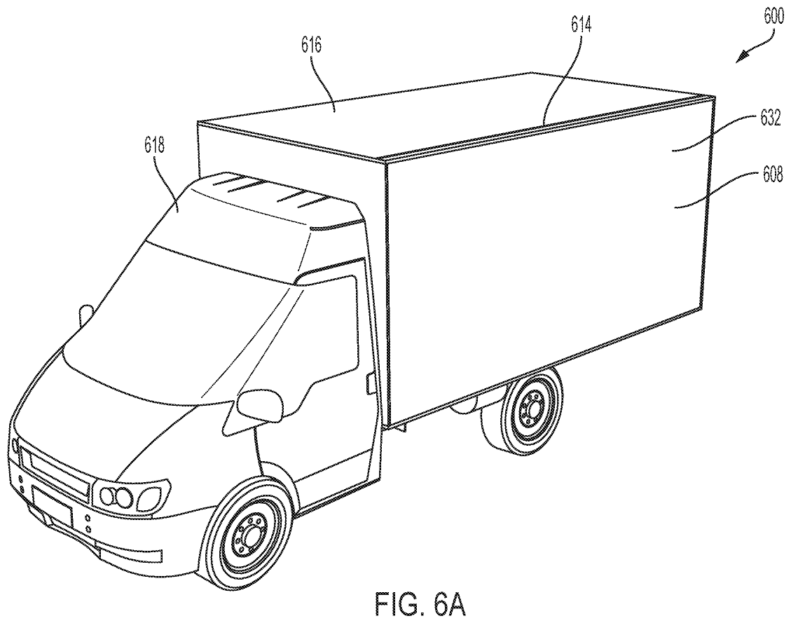

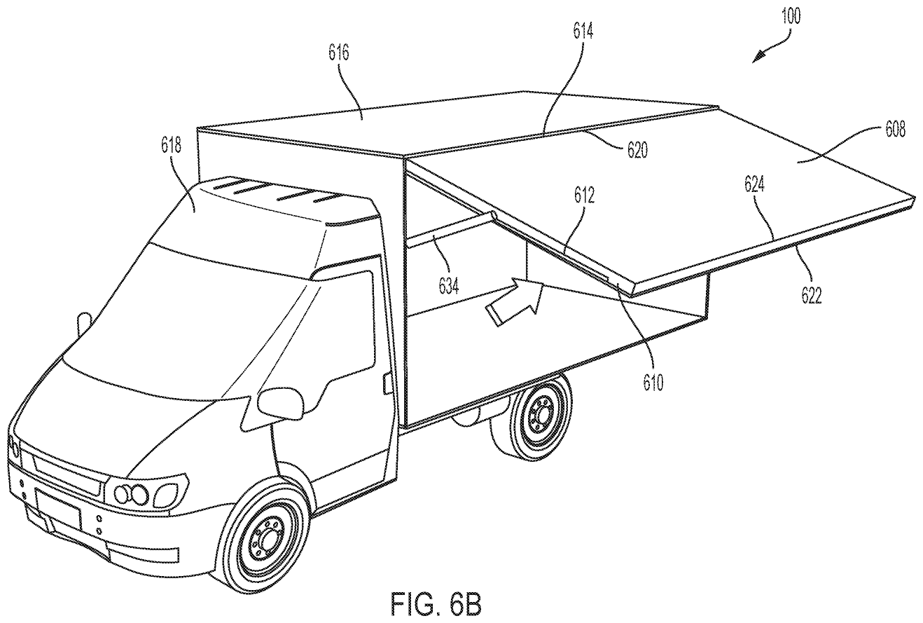

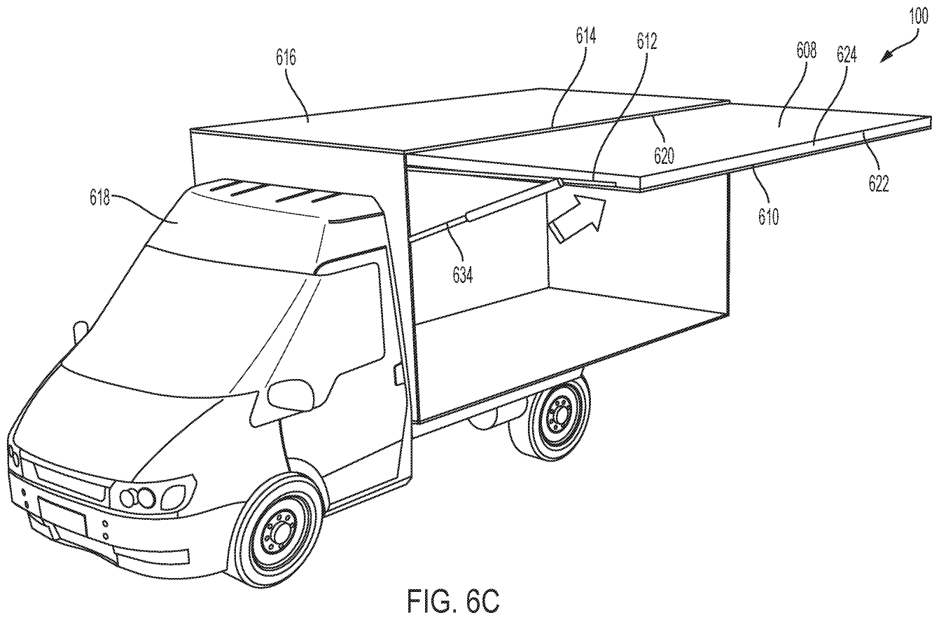

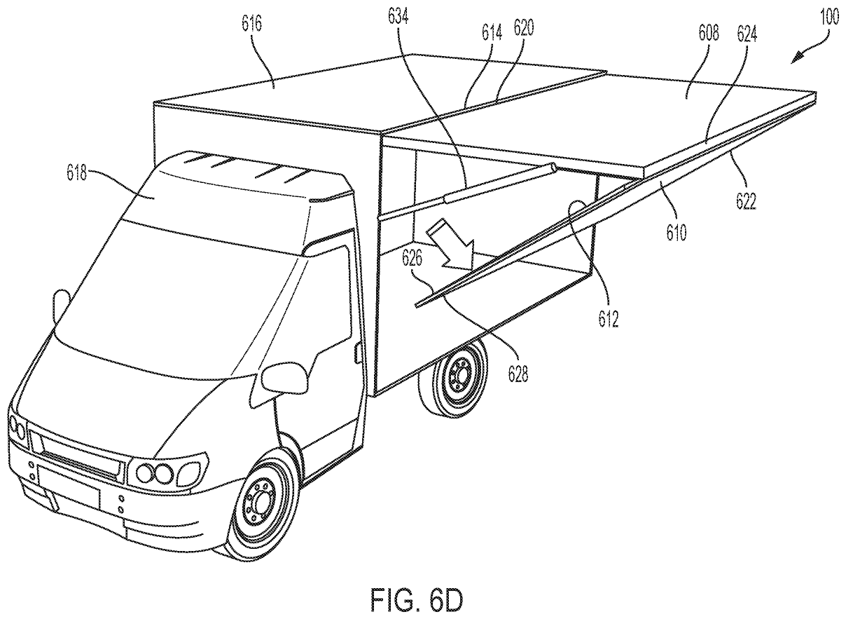

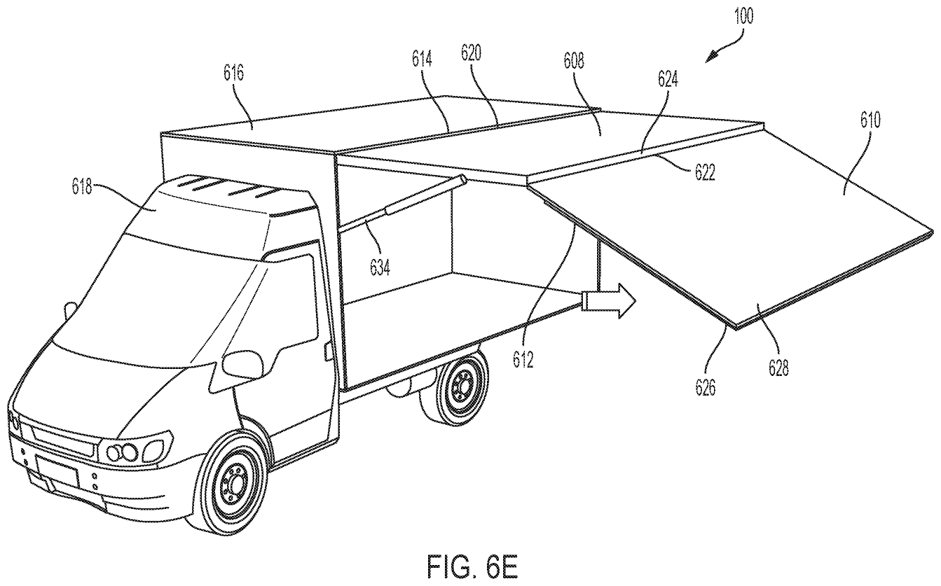

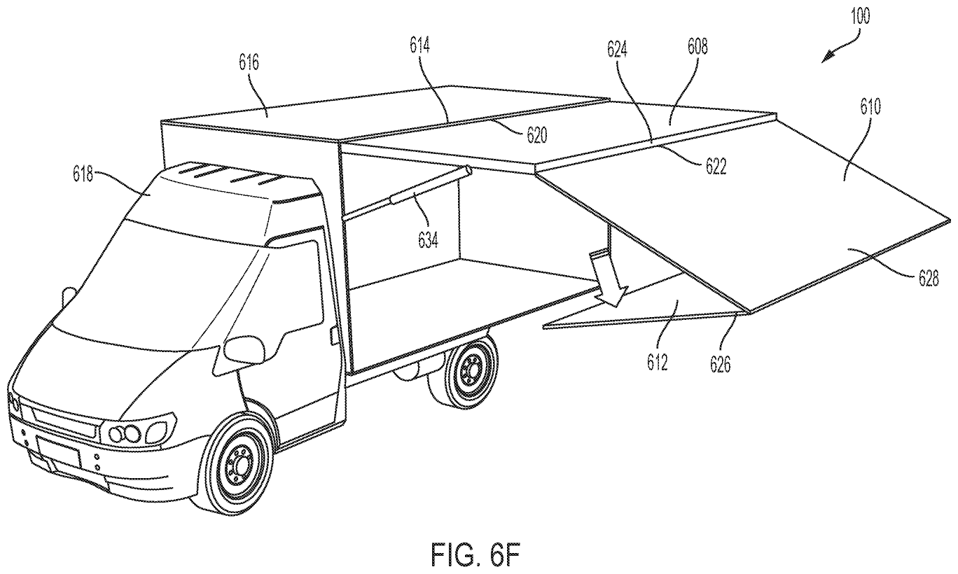

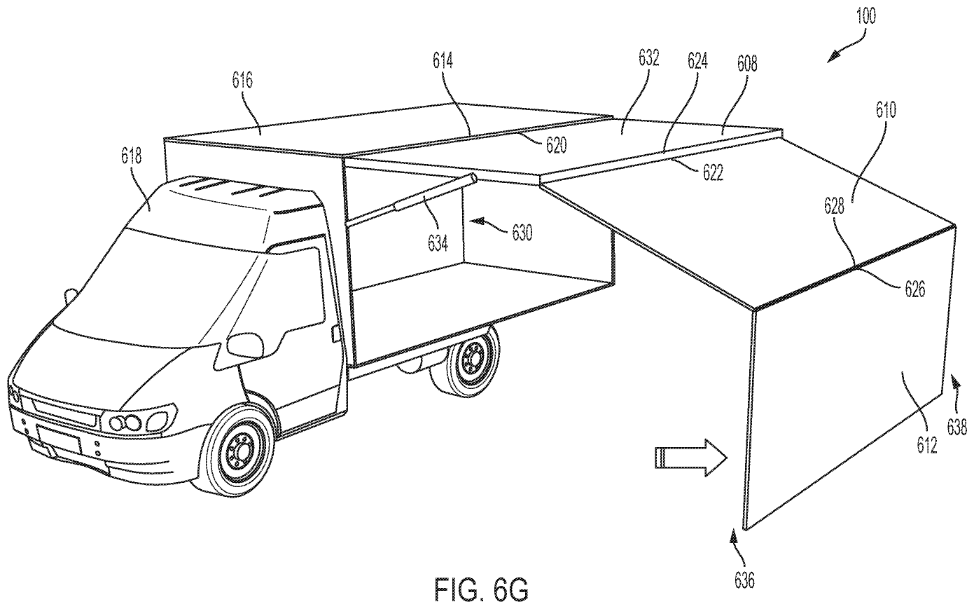

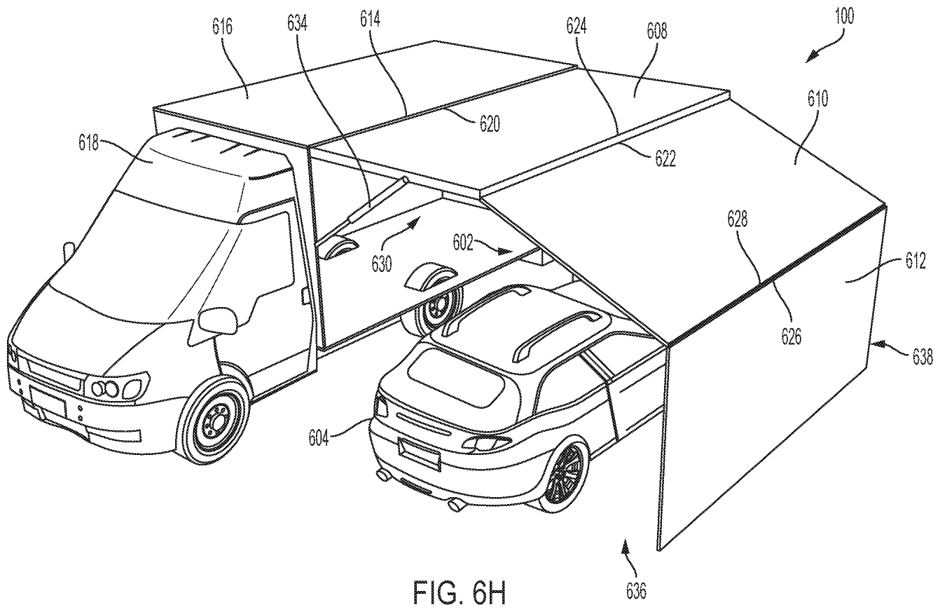

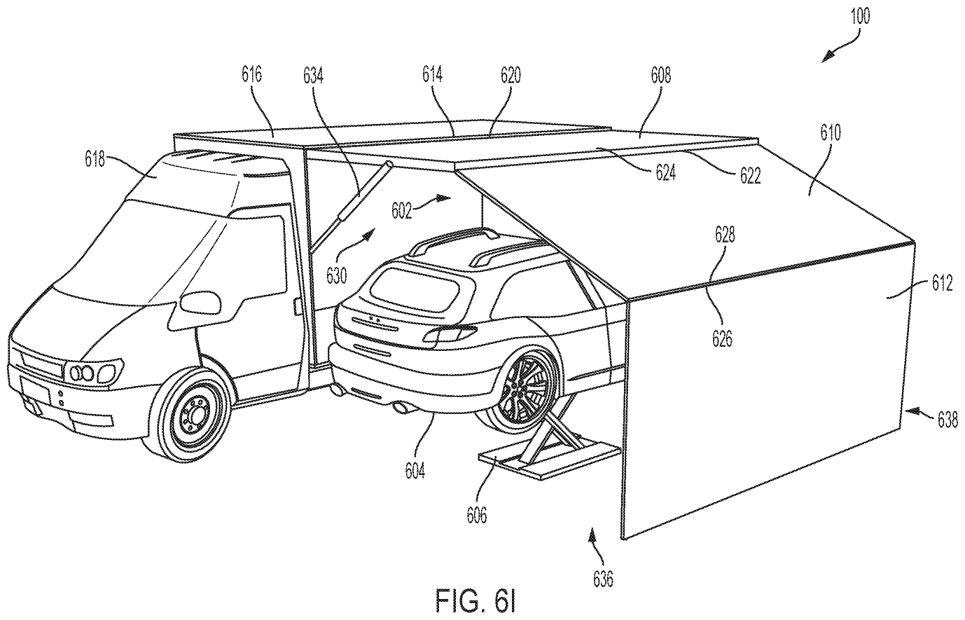

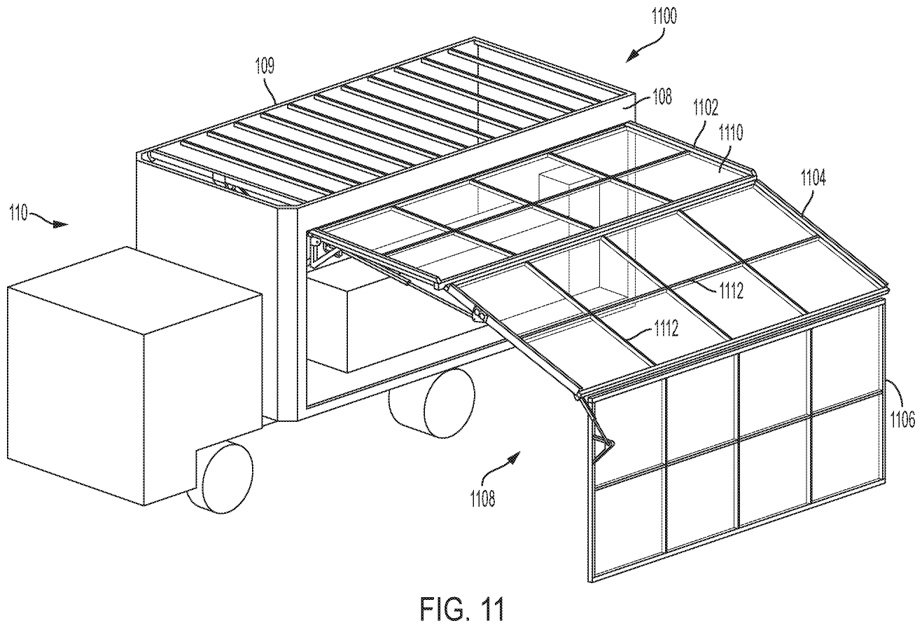

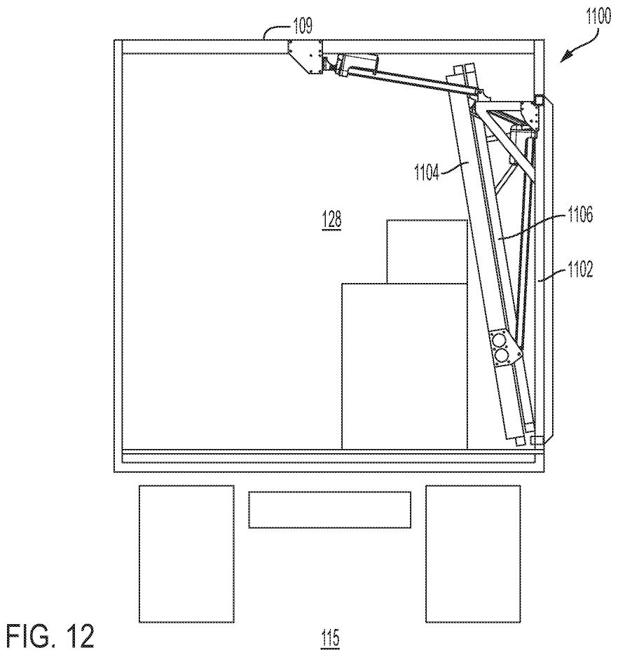

FIGS. 6A-I show another example embodiment of a mobile articulating vehicle service shelter 600 in various states of deployment. It should be appreciated that any of the features and/or functionality of the shelter 600 described herein may likewise be employed on or with the shelter 100 described herein and/or the shelter 1100 described below in connection with FIGS. 11 and 12, and vice-versa.

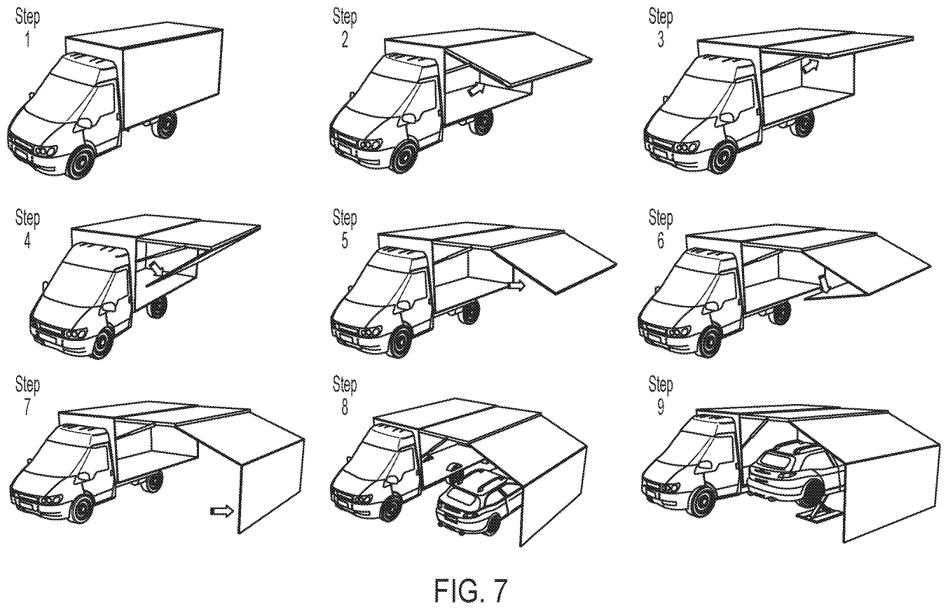

FIGS. 6H and 6I illustrate how sufficient headroom may be provided within an interior region 602 of the shelter 600 to allow a vehicle 604 to be raised by a lift 606, thus allowing service technicians to access an underside of the vehicle 604. FIG. 7 shows FIGS. 6A through 6I as a sequence of steps, identified as steps 1 through 9, respectively, for deploying the shelter 600 and lifting the vehicle 604 within the interior region 602. The manner in which the panels are articulated in the illustrated steps is consistent with the second implementation discussed above in connection with FIGS. 5A-C. In should be appreciated that the example shelter 100 shown in FIGS. 1-3 as well as the example shelter 1100 described below in connection with FIGS. 11 and 12 may, in some embodiments, likewise be deployed using a similar sequence of steps. Each type of shelter 100, 600, 1100 may advantageously be transported to the site of a vehicle in need of repairs and/or maintenance and then deployed over the vehicle, or the vehicle may be moved into the shelter 100, 600, 1100 after it has been deployed, to allow technicians to service the vehicle within the interior region 119, 602, 1108.

As shown in FIGS. 6A-6I, in some embodiments, the shelter 600 may include a set of three panels 608, 610, 612, which may be analogous to the panels 102, 104, 106 described above, that collectively form a tri-fold enclosure. In some embodiments, each of the three panels 608, 610, 612 may be a rigid structure. In the example shown, a first edge 620 of a first panel 608 is pivotally attached to an upper edge 614 of a cargo portion 616 of a carrier vehicle 618, e.g., a truck, van, or other wheeled vehicle, a first edge 622 of a second panel 610 is pivotally attached to a second edge 624 of the first panel 608, and a first edge 626 of a third panel 612 is pivotally attached to a second edge 628 of the second panel 610. In some embodiments, the first panel 608 may form a generally horizontal roof portion, the second panel 610 may form an angled roof portion, and the third panel 612 may form a generally vertical front wall for the shelter 600. As illustrated, in some embodiments, one or more extendable connectors 634 may be used to facilitate and/or control movement of the first panel 608 with respect to the cargo portion 616. In other embodiments, one or more such extendable connectors may additionally or alternatively be used to facilitate and/or control movement of the second panel 610 with respect to the first panel 608 and/or to facilitate and/or control movement of the third panel 612 with respect to the second panel 610. In some embodiments, the shelter 600 may be configured so that it can be quickly deployed by a solo operator. In some embodiments, for example, the tri-fold structure may be deployed with hydraulic, pneumatic, electromotive, and/or or mechanical assistance. In some embodiments, for example, one or more of the above-described extendable connectors may be pneumatically operated and/or may include electromechanical worm gear drive actuators, or the like.

In some embodiments, each of the three panels 608, 610, 612 may have approximately the same width, thus maximizing the volume of the interior region 602. In some embodiments, at least one of the panels may be slightly narrower than one or both of the other panels so as to allow the panels to fold properly. In one example embodiment, for instance, the first and second panels 608, 610 may each ninety-two inches wide, and the third panel 612 may be eighty-four and one-quarter inches wide, thus allowing the third panel 612 to be folded within and sandwiched between the first panel 608 and the second panel 610. Further, in such an embodiment, the length of the cargo portion 616 may be approximately one hundred and ninety-two inches. As illustrated, in some embodiments, the first, second and third panels 608, 610, 612 may collectively form one of the walls of the cargo portion 616. In such embodiments, when the tri-fold structure is in its deployed state (as shown in FIGS. 6G-6I), an interior region 630 of the cargo portion 616 may be exposed to the interior region 602 of the shelter, thus allowing service technicians to access equipment, tools, etc., within the interior region 630 while they are servicing a vehicle 604 within the shelter 600.

As shown in FIGS. 6A and 6G, in some embodiments, a first surface 632 of the first panel 608 may form an outer surface a wall of the cargo portion 616 when the tri-fold structure is in a non-deployed state, and may also form a top surface of a roof of the shelter 600 when the tri-fold structure is in a deployed state. In some embodiments, the first panel 608 and/or the first surface 632 of the first panel 608 may be configured differently than the other panels, to allow the first panel 608 to withstand the harsher environmental conditions and/or more extensive environmental exposure to which it will be subjected as compared to the other panels.

In a similar fashion, the first generally planar surface 122 of the first panel 102 shown in FIGS. 1-3 and a first generally planar surface 1110 of the first panel 1102 shown in FIGS. 11 and 12 may likewise be configured differently than the other panels, to allow the first panel 102, 1102 to withstand the harsher environmental conditions and/or more extensive environmental exposure to which it will be subjected as compared to the other panels.

In some embodiments, the shelters 100, 600, 1100 may be sufficiently large to perform work on a customer vehicle, including access to all sides of the vehicle. In some embodiments, the interior region 119, 602, 1108 may be made fully enclosed using extendable vertical walls (not shown) that cover both ends, e.g., ends 636 and 638 shown in FIGS. 6G-I, of the enclosure. In some embodiments, such vertical walls may be made of fabric and/or some other structure or material that may be readily collapsed and stored when the shelter 100, 600, 1100 is in a non-deployed state. In some embodiments, one or both of such vertical walls may be made of a stretchable fabric that may press directly up against the vehicle, thus allowing a technician to stretch the fabric and move around the vehicle without exiting the shelter 100, 600, 1100. Such embodiments may be advantageous, for example, for vehicles 117, 604 that are about the same length or longer than the panels 102, 104, 106, 608, 610, 612, 1102, 1104, 1106. In some embodiments, one of more of the panels 102, 104, 106, 608, 610, 612, 1102, 1104, 1106 and/or the vertical walls (not shown) may include windows made, for example, from a transparent synthetic material. In some embodiments, vertical walls on one or both of the ends of the shelter 100, 600, 1100 may be remain affixed to the shelter 100, 600, 1100 when the shelter 100, 600, 1100 is converted from its deployed state to its un-deployed state, and vice-versa, such that each such vertical wall extends over and covers an end of the shelter automatically during deployment. In some embodiments, vertical walls on one or both of the ends of the shelter 100, 600, 1100 may additional or alternatively be selectively detachable and/or movable, so that one or more passageways for a vehicle to be serviced and/or service personnel may be temporarily formed.

In some embodiments, the interior region 119, 602, 1108 may be heated and/or air conditioned to provide a temperate work environment. The use of vertical walls, as described above, may increase the efficiency and/or effectiveness of such climate control measures.

In some embodiments, pairs of the panels 102, 104, 106, 608, 610, 612, 1102, 1104, 1106 may be interconnected with cross-bracings or other rigid structures once deployed to provide added stability.

In some embodiment, one or more of the panels 102, 104, 106, 608, 610, 612, 1102, 1104, 1106 and/or the vertical walls (described above) may be made of waterproof materials to prevent ingress of rain and/or snow.

FIG. 8 shows a side view of the shelter 100 (shown in FIGS. 1-3) in the deployed state, and illustrates example linkages and linear actuators that may be used in some embodiments to control the positioning and movement of the panels 102, 104, 106 with respect to the cargo portion 109 of the transport vehicle 110. Although described in the context of the embodiment of the shelter 100 shown in FIGS. 1-3, it should be appreciated that similar linkages and linear actuators may likewise be used in connection with the shelter 600 described in connection with FIGS. 6A-6I as well as the shelter 1100 described below in connection with FIGS. 11 and 12.

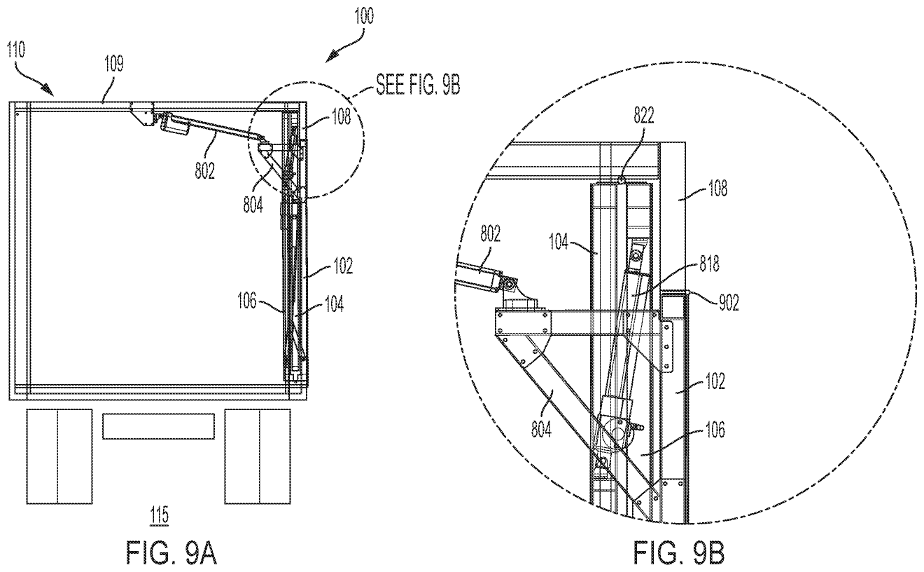

As shown in FIG. 8, in some embodiments, a first linear actuator 802 may drive a gusset 804 that is fixedly attached to the first panel 102 so as to cause the first panel 102 rotate about a first pivot point 806. The first pivot point 806 may be formed, for example, using one of more hinges (e.g., see hinge 902 shown in FIG. 9B) connected between the first panel 102 and the first side 108 of the cargo portion 109 of the transport vehicle 110. In some embodiments, a second linear actuator 808 may drive linkages 810a, 810b so as to cause the second panel 104 to rotate with respect to the first panel 104 about a second pivot point 812. As shown, the second pivot point 812 may be formed using one or more hinges 814 connected between the first panel 102 and the second panel 104. In the example shown, the linkage 810a is pivotally coupled to the first panel 102, the linkage 810b is pivotally coupled to the second panel 104, and the two linkages 810a, 810b are pivotally connected together a point 616 that is driven by the linear actuator 808. In some embodiments, a third linear actuator 818 may additionally or alternatively be coupled between the second panel 104 and the third panel 106 so as to cause the third panel 106 to rotate with respect to the second panel 104 about a third pivot point 820. Similar to the second pivot point 812, the third pivot point 820 may be formed using one or more hinges 822 connected between the second panel 104 and the third panel 106.

FIG. 9A shows the shelter 100, including the linkages and actuators shown in FIG. 8, in the un-deployed state. FIG. 9B shows detail of the circled region indicated in FIG. 9A. As illustrated in FIGS. 9A and 9B, in the un-deployed state, the first panel 102, the second panel 104, and the third panel 104 may all be generally vertical with respect to the surface 115 underneath the transport vehicle 110.

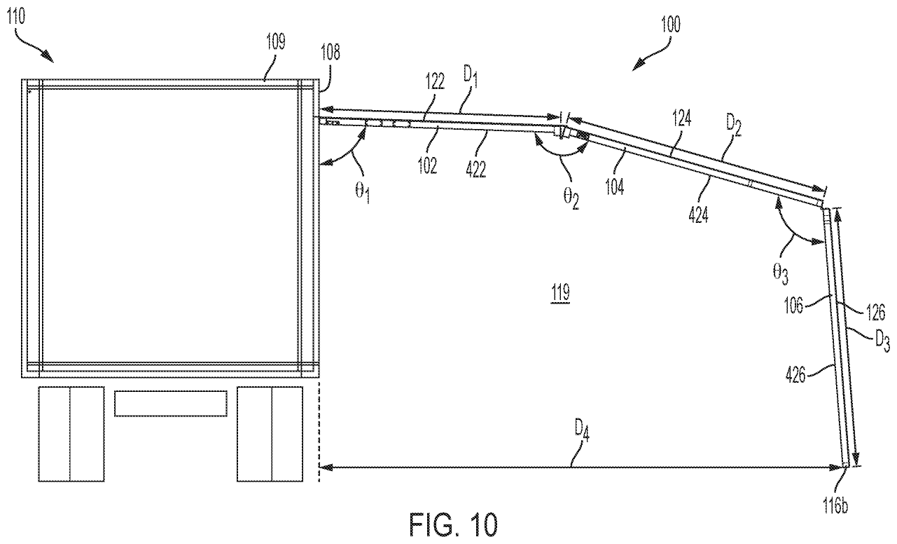

FIG. 10 shows the example configuration of the shelter 100 shown in FIGS. 9A and 9B, but with the actuators and linkages omitted. As can be seen, in the illustrated embodiment, in the un-deployed state, the second generally planar side 422 of the first panel 102 forms a first interior angle θ₁ with respect to the first side 108 of the cargo portion 109 that is approximately equal to ninety degrees (and possibly slightly less to allow water to freely run off the first generally planar side 122), the second generally planar side 424 of the second panel 104 forms a second interior angle θ₂ with respect to the second generally planar side 422 of the first panel 101 that is approximately one hundred and sixty-six degrees, and the second generally planar side 426 of the third panel 106 forms a third interior angle θ₃ with respect to the second generally planar side 424 of the second panel 104 that is approximately one hundred and six degrees.

In some embodiments, the second interior angle θ₂ may be greater than ninety degrees, or greater than ninety-five degrees, or greater than one hundred degrees, or greater than one hundred and five degrees, or greater than one hundred and ten degrees, or greater than one hundred and fifteen degrees, or greater than one hundred and twenty degrees, or greater than one hundred and twenty-five degrees, or greater than one hundred and thirty degrees, or greater than one hundred and thirty-five degrees, or greater than one hundred and forty degrees, or greater than one hundred and forty-five degrees, or greater than one hundred and fifty degrees, or greater than one hundred and fifty-five degrees, or greater than one hundred and sixty degrees, or greater than one hundred and sixty-five degrees, or greater than one hundred and seventy degrees, or greater than one hundred and seventy-five degrees. Additionally or alternatively, in some embodiments, the third interior angle θ₃ may be greater than ninety degrees, or greater than ninety-five degrees, or greater than one hundred degrees, or greater than one hundred and five degrees, or greater than one hundred and ten degrees, or greater than one hundred and fifteen degrees, or greater than one hundred and twenty degrees, or greater than one hundred and twenty-five degrees, or greater than one hundred and thirty degrees, or greater than one hundred and thirty-five degrees, or greater than one hundred and forty degrees, or greater than one hundred and forty-five degrees, or greater than one hundred and fifty degrees, or greater than one hundred and fifty-five degrees, or greater than one hundred and sixty degrees, or greater than one hundred and sixty-five degrees, or greater than one hundred and seventy degrees, or greater than one hundred and seventy-five degrees.

In FIG. 10, the distances D1, D2, D3 between the edges of the respective panels 102, 104, 106 as well as the distance D4 between the first side 108 of the cargo portion 109 and the second edge 116b of the third panel 106 (as introduced above in connection with FIG. 1) are also specified. As noted above, in some embodiments, the distance D4 may be at least as great as the distance D1. In some embodiments, the distance D4 may be more than five percent greater than the distance D1, or more than ten percent greater than the distance D1, or more than fifteen percent greater than the distance D1, or more than twenty percent greater than the distance D1, or more than twenty-five percent greater than the distance D1, or more than thirty percent greater than the distance D1, or more than thirty-five percent greater than the distance D1, or more than forty percent greater than the distance D1, or more than forty-five percent greater than the distance D1, or more than fifty percent greater than the distance D1, or more than fifty-five percent greater than the distance D1, or more than sixty percent greater than the distance D1, or more than sixty-five percent greater than the distance D1, or more than seventy percent greater than the distance D1, or more than seventy-five percent greater than the distance D1, or more than eighty percent greater than the distance D1, or more than eighty-five percent greater than the distance D1, or more than ninety percent greater than the distance D1, or more than ninety-five percent greater than the distance D1, or more than one hundred percent greater than the distance D1.

In some embodiments, the distance D4 may additionally or alternatively be at least twenty-five percent of the sum of the distance D1 and the distance D2, or at least thirty percent of the sum of the distance D1 and the distance D2, or at least thirty-five percent of the sum of the distance D1 and the distance D2, or at least forty percent of the sum of the distance D1 and the distance D2, or at least forty-five percent of the sum of the distance D1 and the distance D2, or at least fifty percent of the sum of the distance D1 and the distance D2, or at least fifty-five percent of the sum of the distance D1 and the distance D2, or at least sixty percent of the sum of the distance D1 and the distance D2, or at least sixty-five percent of the sum of the distance D1 and the distance D2, or at least seventy percent of the sum of the distance D1 and the distance D2, or at least seventy-five percent of the sum of the distance D1 and the distance D2.

Further, in some embodiments, the distance D4 may additionally or alternatively be at least forty percent of the sum of the distance D1, the distance D2 and the distance D3, or at least forty-five percent of the sum of the distance D1, the distance D2 and the distance D3, or at least fifty percent of the sum of the distance D1, the distance D2 and the distance D3, or at least fifty-five percent of the sum of the distance D1, the distance D2 and the distance D3, or at least sixty percent of the sum of the distance D1, the distance D2 and the distance D3, or at least sixth-five percent of the sum of the distance D1, the distance D2 and the distance D3, or at least seventy percent of the sum of the distance D1, the distance D2 and the distance D3, or at least seventy-five percent of the sum of the distance D1, the distance D2 and the distance D3, or at least eighty percent of the sum of the distance D1, the distance D2 and the distance D3.

FIG. 11 shows another example embodiment of a mobile articulating vehicle service shelter 1100 in its deployed state. FIG. 12 shows a cross section of the shelter 1100 shown in FIG. 11 in its un-deployed state. The shelter 1100 is similar in many respects to the shelters 100, 600 described above, but it employs slightly different actuators and linkages to transition the shelter from its un-deployed state to its deployed state, and vice-versa, and also includes a different configuration of structural members 1112 within the respective panels 1102, 1104, 1106. As can be seen in FIG. 12, in the un-deployed state, the panels 1102, 1104, 1106 are not all perfectly vertical with respect to the surface 115 underneath the vehicle, and two of them (i.e., panels 1104 and 1106) are instead leaning slightly toward the interior region 128 of the cargo portion 109. In this regard, it should be appreciated that, as used herein, the terms “generally vertical” and “generally horizontal” are intended to encompass orientations that are not precisely vertical or horizontal and that may be offset from vertical or horizontal by as much as twenty degrees. Similarly, the term “generally parallel,” as used herein, is intended to encompass orientations of planes or other elements that are not precisely parallel and that may be offset from one another by as much as twenty degrees. For example, with respect to the un-deployed state of the shelter shown in FIG. 12, the first panel 1102, the second panel 1104, and the third panel 1106 should all be considered “generally vertical” with respect to the surface 115 underneath the vehicle 110 as that term is used herein, and the planes in which the first panel 1102, second panel 1104, and third panel 1106 are generally disposed should all be considered “generally parallel” to one another as that term is used herein.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A transportable shelter configured to have an un-deployed state and a deployed state, the transportable shelter comprising:
a first panel having a first edge and a second edge, the second edge of the first panel being generally parallel to and spaced a first distance from the first edge of the first panel;
a second panel having a first edge and a second edge, the second edge of the second panel being generally parallel to and spaced a second distance from the first edge of the second panel;
a third panel having a first edge and a second edge, the second edge of the third panel being generally parallel to and spaced a third distance from the first edge of the third panel;
the first edge of the first panel is pivotally coupled to an upper region of a first side of a wheeled vehicle and is generally horizontal with respect to a surface underneath the wheeled vehicle;
the first edge of the second panel is pivotally coupled to the second edge of the first panel;
the first edge of the third panel is pivotally coupled to the second edge of the second panel; and
when the transportable shelter is in the deployed state, the second edge of the third panel is spaced apart from the first side by a fourth distance that is at least as great as the first distance.

2. The transportable shelter of claim 1, wherein, when the transportable shelter is in the un-deployed state:
the first panel is generally vertical with respect to the surface; and
the third panel is between the first panel and the second panel.

3. The transportable shelter of claim 1, wherein, when the transportable shelter is in the un-deployed state:
the first panel is generally vertical with respect to the surface; and
the second panel is between the first panel and the third panel.

4. The transportable shelter of claim 1, wherein:
the first panel is disposed generally in a first plane that intercepts both the first edge and the second edge of the first panel;
the second panel is disposed generally in a second plane that intercepts both the first edge and the second edge of the second panel;
the third panel is disposed generally in a third plane that intercepts both the first edge and the second edge of the third panel; and
when the transportable shelter is in the un-deployed state, the first, second, and third planes are generally vertical with respect to the surface.

5. The transportable shelter of claim 4, wherein:
the first panel has a first generally planar side and a second generally planar side, the second generally planar side of the first panel being opposite the first generally planar side of the first panel;
the second panel has a first generally planar side and a second generally planar side, the second generally planar side of the second panel being opposite the first generally planar side of the second panel;
the third panel has a first generally planar side and a second generally planar side, the second generally planar side of the third panel being opposite the first generally planar side of the third panel; and
when the transportable shelter is in the deployed state:
the second general planar side of the first panel, the second generally planar side of the second panel, and the second generally planar side of the third panel all face an interior region of the transportable shelter, and
the first general planar side of the first panel, the first generally planar side of the second panel, and the first generally planar side of the third panel all face away from the interior region.

6. The transportable shelter of claim 5, wherein, when the transportable shelter is in the un-deployed state:
the second generally planar side of the third panel directly faces the second generally planar side of the second panel; and
the first generally planar side of the third panel directly faces the second generally planar side of the first panel.

7. The transportable shelter of claim 5, wherein, when the transportable shelter is in the un-deployed state:
the second generally planar side of the second panel directly faces the second generally planar side of the first panel; and
the first generally planar side of the third panel directly faces the first generally planar side of the second panel.

8. The transportable shelter of claim 5, in combination with the wheeled vehicle, wherein the first side of the wheeled vehicle includes an opening positioned such that:
when the transportable shelter is in the deployed state, an interior portion of the wheeled vehicle is exposed to the interior region; and
when the transportable shelter is in the un-deployed state, the opening is covered by at least the first panel.

9. The transportable shelter of claim 5, further comprising at least one flexible fabric sheet attached to the first, second and third panels such that, when the transportable shelter is in the deployed state, the interior region of the shelter is defined by a combination the second general planar side of the first panel, the second generally planar side of the second panel, the second generally planar side of the third panel, and the at least one flexible fabric sheet.

10. The transportable shelter of claim 5, wherein, when the transportable shelter is in the deployed state, an interior angle between the second generally planar side of the first panel and the second generally planar side of the second panel is greater than ninety degrees.

11. The transportable shelter of claim 5, wherein, when the transportable shelter is in the deployed state, an interior angle between the second generally planar side of the second panel and the second generally planar side of the third panel is between ninety and one hundred and eighty degrees.

12. The transportable shelter of claim 1, further comprising:
a first actuator configured and arranged to cause the first panel to pivot with respect to the first side via at least one first pivotal connection between the first edge of the first panel and the first side;
a second actuator configured and arranged to cause the second panel to pivot with respect to the first panel via at least one second pivotal connection between the first edge of the second panel and the second edge of the first panel; and
a third actuator configured and arranged to cause the third panel to pivot with respect to the second panel via at least one third pivotal connection between the first edge of the third panel and the second edge of the first panel.

13. The transportable shelter of claim 1, wherein the fourth distance is greater than the second distance.

14. The transportable shelter of claim 1, wherein the fourth distance is at least forty percent of the sum of the first distance and the second distance.

15. The transportable shelter of claim 1, wherein the fourth distance is at least fifty percent of the sum of the first distance, the second distance, and the third distance.

16. A method for operating a transportable shelter that includes a first panel, a second panel, and a third panel, wherein:
the first panel has a first generally planar side and a second generally planar side,
the second generally planar side of the first panel is opposite the first generally planar side of the first panel,
the second panel has a first generally planar side and a second generally planar side,
the second generally planar side of the second panel is opposite the first generally planar side of the second panel,
the third panel has a first generally planar side and a second generally planar side,
the second generally planar side of the third panel is opposite the first generally planar side of the third panel,
the first panel has a first edge and a second edge,
the second edge of the first panel is generally parallel to and spaced a first distance from the first edge of the first panel,
the second panel has a first edge and a second edge,
the second edge of the second panel is generally parallel to and spaced a second distance from the first edge of the second panel,
the third panel has a first edge and a second edge, and
the second edge of the third panel is generally parallel to and spaced a third distance from the first edge of the third panel;
the method comprising:
causing the first panel to rotate about a first pivot point between the first edge of the first panel and a first side of a wheeled vehicle so that the first panel transitions from a first position in which the first generally planar side of the first panel is generally vertical with respect to a surface underneath the wheeled vehicle to a second position in which the first generally planar side is generally horizontal with respect to the surface;
causing the second panel to rotate through more than ninety degrees with respect the first panel and about a second pivot point between the first edge of the second panel and the second edge of the first panel so that the second panel transitions from a third position in which the second generally planar side of the second panel is generally parallel to the second generally planar side of the first panel to a fourth position in which a first interior angle between the second generally planar side of the second panel and the second generally planar side of the first panel is greater than ninety degrees; and
causing the third panel to rotate through more than ninety degrees with respect the second panel and about a third pivot point between the first edge of the third panel and the second edge of the second panel so that the third panel transitions from a fifth position in which the second generally planar side of the third panel is generally parallel to the second generally planar side of the second panel to a sixth position in which a second interior angle between the second generally planar side of the third panel and the second generally planar side of the second panel is greater than ninety degrees and in which the second edge of the third panel is spaced apart from the first side.

17. The method of claim 16, wherein:
when the third panel is in the third position, the second edge of the third panel is spaced apart from the first side by a fourth distance that is at least as great as the first distance

18. The method of claim 16, wherein, when the second panel is in the third position and the third panel is in the fifth position, the second generally planar side of the third panel directly faces the second generally planar side of the second panel, and the first generally planar side of the third panel directly faces the second generally planar side of the first panel.

19. The method of claim 16, wherein, when the second panel is in the third position and the third panel is in the fifth position, the second generally planar side of the second panel directly faces the second generally planar side of the first panel, and the first generally planar side of the third panel directly faces the first generally planar side of the second panel.

20. The method of claim 16, further comprising:
using at least one linear actuator to cause the first panel to rotate about the first pivot point.
